(19) United States
(12) Patent Application Publication
(10) Pub. No.: US 2011/0221806 A1
(43) Pub. Date: Sep. 15, 2011

(54) IMAGE PROCESSOR, IMAGE PROCESSING METHOD, IMAGE PRINTING METHOD AND STORAGE MEDIUM

(75) Inventor: Kazuyoshi Sumiuchi, Kawasaki-shi (JP)

(73) Assignee: CANON KABUSHIKI KAISHA, Tokyo (JP)

(21) Appl. No.: 13/033,836

(22) Filed: Feb. 24, 2011

(30) Foreign Application Priority Data
Mar. 15, 2010 (JP) 2010-057495

(51) Int. Cl. B41J 29/38

(52) U.S. Cl. 347/9

(57) ABSTRACT

The present invention allows for printing a high quality image based on print data which is obtained by dividing multivalue image data into portions, one for each scan, and quantizing the divided portions of image data. To this end, multivalue input data is divided into input pass data for each scan, which is then corrected using error data. The corrected input values are added up to determine a total corrected input value. The total corrected input value is quantized into a total output value, which has fewer gradation levels than the input data. The total output value is then distributed unevenly among a plurality of printing scans to generate print data for each scan.

### BACKGROUND OF THE INVENTION

1. Field of the Invention

The present invention relates to an image processor, an image processing method, an image printing method and a storage medium, all for a multipass printing operation that forms an image on a print medium by executing two or more scans of a print head over the same print area on the print medium.

2. Description of the Related Art

Among the printing apparatus used for a multipass printing method there is known an inkjet printing apparatus (inkjet printer) of a serial scan type that uses an inkjet print head capable of ejecting ink from a plurality of nozzles.

The inkjet printer repetitively alternates a printing scan for ejecting ink from the print head as it reciprocally moves in a main scan direction and a conveyance operation for feeding the print medium in a sub-scan direction crossing the main scan direction, thereby progressively forming an image on the print medium. The multipass printing method for scanning the print head over the same print area two or more times is able to prevent a possible degradation of quality of a printed image that is likely to occur with a one-pass printing method for scanning the print head over the same print area of a print medium only once.

FIG. 10 shows an example operation performed by a 2-pass printing method, which scans a print head over the same print area of a print medium twice. The print head H is reciprocally movable in the main scan direction of arrow X and the print medium P is fed in a sub-scan direction of arrow Y that crosses (in this example, perpendicularly) the main scan direction. The print head H has formed therein a plurality of nozzles N that can eject ink. For the sake of simplicity, only eight nozzles are shown in FIG. 10. There may be variations in size and ejection direction among ink droplets ejected from the individual nozzles N due to physical factors of the print head H. In the 2-pass printing method, each time the print head H executes one scan, the print medium P is fed a distance equal to four nozzles in the sub-scan direction, so that each dot position on the same line L of the print medium P is printed with ink droplets ejected from two different nozzles N. As a result, the effect of variations in size and ejection direction of ink droplets ejected from the individual nozzles N can be minimized.

In this example, the print data for printing an image in a first scan using the lower four nozzles N of the print head H in FIG. 10 is thinned in a staggered pattern by a mask pattern, as shown in FIG. 11A. In a second scan the print data for printing an image using the upper four nozzles N of the print head H in FIG. 10 is thinned in a reversed staggered pattern by a mask pattern, as shown in FIG. 11B. In an area printed by two scans of the print head, the print data is thinned in the first and second scan in a complementary manner. The print data for the second scan (FIG. 11B) using the lower four nozzles N of FIG. 10 and the print data for the third scan (FIG. 11C) using the upper four nozzles N of FIG. 10 are also thinned in a similar way. As described above the print data is divided for each scan.

In expressing a gradation level in one pixel, there are a multidrop technique and a droplet modulation technique. The multidrop method expresses a gradation level by changing the number of ink droplets ejected onto a single pixel, while the droplet modulation technique changes the volume of an ink droplet ejected onto a single pixel.

FIG. 12A and FIG. 12B show a process of dividing print data in the above 2-pass printing method in which multivalued image data (256-value image data) ranging from 0 to 255 is quantized into three-value print data (0, 1, 2) which is then divided for each printing scan. Of the three-value print data a value “0” represents no ink ejection, “1” an ejection of a small ink droplet and “2” an ejection of a large ink droplet.

FIG. 12A shows an example process of transforming image data corresponding to a solid image with a gradation level of “128” into three-value print data and then dividing the three-value print data into portions for two passes. The three-value print data is thinned in a staggered pattern and a reversed staggered pattern (staggered pattern masking process). For the solid image with a gradation level of “128”, its image data is quantized into a value “1” so that the image will be printed with 100% small dots. The quantized print data is then divided into data for two passes so that 50% of the small dots are formed in each pass. Therefore the print data thinning patterns for the first pass and the second pass are in a truly complementary relationship. In the example of FIG. 12B, the solid image print data with a gradation level of “255” is quantized into a value “2” so that the image will be printed with 100% large dots. The quantized data is then divided into data for two passes so that 50% of the large dots are formed in each pass. In this case, too, the print data thinning patterns for the first pass and the second pass are in a perfectly complementary relationship.

Japanese Patent Laid-Open No. 2000-103088 discloses a method of first dividing multivalue image data into portions for each printing scan (pass) before quantizing them. With this method, since the image data is divided into portions for individual passes before being quantized, the complementary relationship between the print data of different passes can be changed so that an undesired effect that may occur when the complementary relationship is perfect can be minimized. That is, if the complementary relationship between the divided data is perfect as shown in FIG. 12A and FIG. 12B, ink droplet landing position variations are likely to appear as density variations in a printed image. But any increase in the number of passes to minimize the effect of variations can result in a lowered printing speed. On the other hand, changing the complementary relation between the divided print data of different passes can minimize the unwanted effect of variations in the ink droplet landing position.

FIG. 13 shows an example process of dividing 256-value image data ranging from 0 to 255 into portions for two passes before quantizing them into three-value print data (0, 1, 2). In this example, image data with a gradation level of “255” is divided into image data of gradation level “128” and image data of gradation level “127”. Since the image data still in the form of multivalue data is divided before quantization, the maximum gradation level (maximum density) of the image data to be quantized becomes smaller than the gradation level before the data division or “255”.

When FIG. 12B and FIG. 13, both with the same gradation level of “255”, are compared, the image of FIG. 12B is printed with 50% of large dots during each of the two passes. In FIG. 13, the image is printed with 100% or nearly 100% of small dots during each pass. That is, the method of FIG. 13, since the image data which is still in the form of multivalue data is divided into portions for individual passes, results in the maximum gradation level (maximum density) becoming lower than that of FIG. 12B. As a result, small ink droplets, which are easily influenced by air flows, are more often ejected continuously as shown in FIG. 13, making the ink droplet landing position variations due to air flows more likely and raising the possibility of density variations occurring in a printed image.

### SUMMARY OF THE INVENTION

The present invention provides an image processor, an image processing method, an image printing method and a storage medium, all for a multipass printing technique capable of printing high-quality images based on print data that has been produced by dividing multivalue image data into portions for individual printing scans, followed by quantization of the divided data.

In the first aspect of the present invention, there is provided an image processor for generating print data used to print an image on a print medium, wherein the image is printed on the print medium by scanning a print head over the same print area of the print medium a plurality of times, the print head being adapted to eject at least two kinds of ink droplets of different volumes onto each pixel according to a value of the print data for the pixel, the image processor comprising:

a dividing unit configured to divide a value of image data, whose range is wider than that of the print data, into portions, one for each scan;

a correction unit configured to correct each of the divided portions of the image data with a correction value of each scan to determine a corrected input value for each scan;

an addition unit configured to add up the corrected input values for the individual scans to calculate a total corrected input value;

a quantization unit configured to quantize the total corrected input value into a value corresponding to the print data to create a total output value; and

a generation unit configured to allocate the total output value unevenly to the plurality of scans to create the print data for each scan.

In the second aspect of the present invention, there is provided an image processing method for generating print data used to print an image on a print medium, wherein the image is printed on the print medium by scanning a print head over the same print area of the print medium a plurality of times, the print head being adapted to eject at least two kinds of ink droplets of different volumes onto each pixel according to a value of the print data for each pixel, the image processing method comprising the steps of:

dividing a value of image data, whose range is wider than that of the print data, into portions, one for each scan;

correcting a value of each of the divided portions of the image data with a correction value of each scan to determine a corrected input value for each scan;

adding up the corrected input values for the individual scans to calculate a total corrected input value;

quantizing the total corrected input value into a value corresponding to the print data to create a total output value; and

allocating the total output value unevenly to the plurality of scans to create the print data for each scan.

In the third aspect of the present invention, there is provided an image printing method for printing an image on a print medium by scanning a print head over the same print area of the print medium a plurality of times, wherein the print head ejects at least two kinds of ink droplets of different volumes onto each pixel according to a value of print data for each pixel which is obtained by quantizing a value of image data for each pixel, the image printing method comprising the steps of:

dividing the value of the image data, whose range is wider than that of the print data, into portions, one for each scan;

correcting a value of each of the divided portions of the image data with a correction value of each scan to determine a corrected input value for each scan;

adding up the corrected input values for the individual scans to calculate a total corrected input value;

quantizing the total corrected input value into a value corresponding to the print data to create a total output value; and

allocating the total output value unevenly to the plurality of scans to create the print data for each scan.

In the fourth aspect of the present invention, there is provided a storage medium storing a computer-readable program, wherein the program causes a computer to execute the following steps to generate print data used to print an image on a print medium, wherein the image is printed on the print medium by scanning a print head over the same print area of the print medium a plurality of times, the print head being adapted to eject at least two kinds of ink droplets of different volumes onto each pixel according to a value of the print data for each pixel, the steps including:

a dividing step to divide a value of image data, whose range is wider than that of the print data, into portions, one for each scan;

a correction step to correct each of the divided portions of the image data with a correction value of each scan to determine a corrected input value for each scan;

an addition step to add up the corrected input value for the individual scans to calculate a total corrected input value;

a quantization step to quantize the total corrected input value into a value corresponding to the print data to create a total output value; and

a generation step to allocate the total output value unevenly to the plurality of scans to create the print data for each scan.

The present invention can keep density variations due to air flow influences from occurring and achieve image quality improvements.

Further features of the present invention will become apparent from the following description of exemplary embodiments (with reference to the attached drawings).

### BRIEF DESCRIPTION OF THE DRAWINGS

FIG. 1 is an outline perspective view of an ink jet printing apparatus to which this invention can be applied;

FIG. 2 is a block configuration diagram of a control system in a first embodiment of this invention;

FIG. 3 is a block diagram of a data processing system in the first embodiment of this invention;

FIG. 4 is a flow chart showing a sequence of steps executed by the data processing system of FIG. 3;

FIG. 5A is an explanatory diagram showing an example of dot arrangement based on a multidrop technique, and FIG. 5B is an explanatory diagram of a dot arrangement by a droplet modulation technique;

FIG. 6 is a block configuration diagram of a multipass print data generation unit of FIG. 3;

FIG. 7 is an explanatory diagram showing processing performed by a total output value calculation unit of FIG. 6;

FIG. 8A and FIG. 8B are tables showing examples of different print data calculated in the first embodiment of this invention;

FIG. 9 is a block configuration diagram of a multipass print data generation unit in a fourth embodiment of this invention;

FIG. 10 is an explanatory diagram of a 2-pass printing technique;

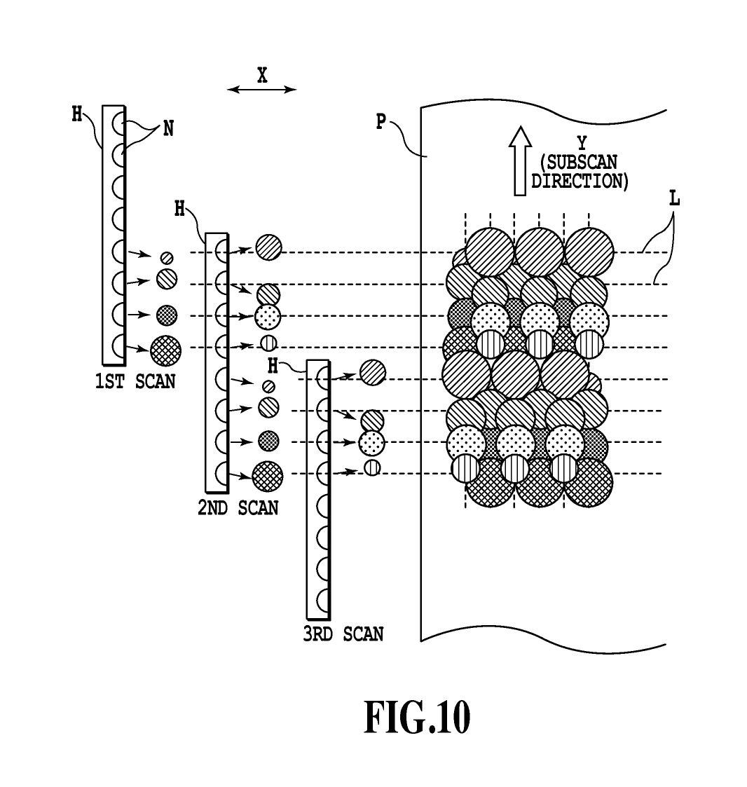

FIG. 11A, FIG. 11B and FIG. 11C are explanatory diagrams of print data thinning patterns in the 2-pass printing technique;

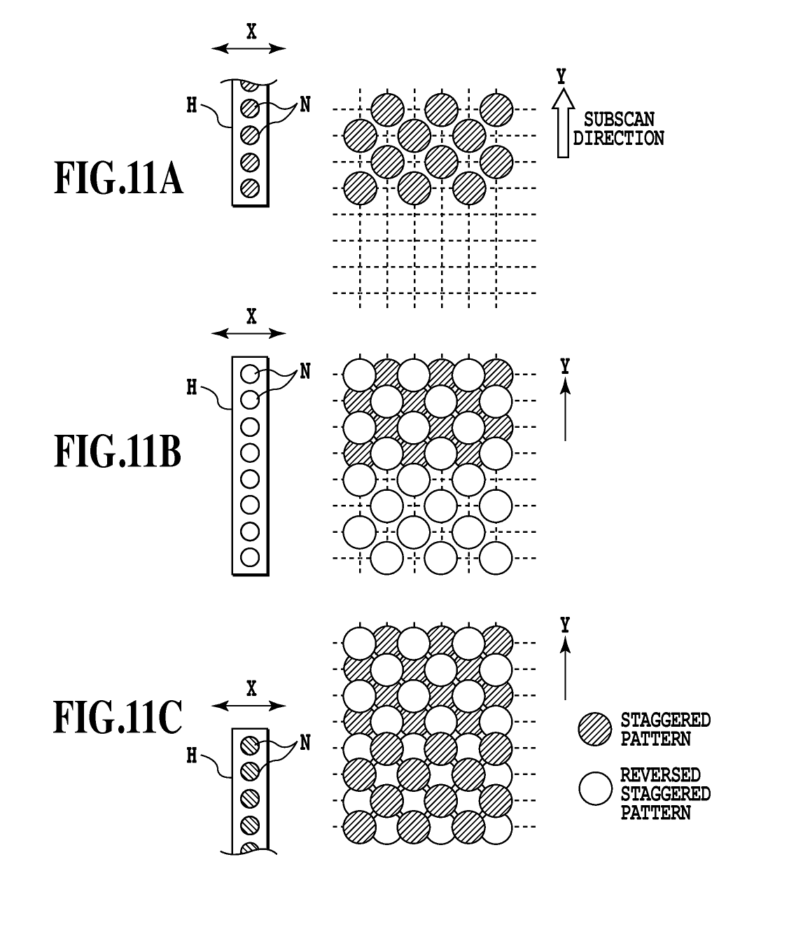

FIG. 12A and FIG. 12B are explanatory diagrams of different processes for dividing image data, after being quantized, into two passes; and

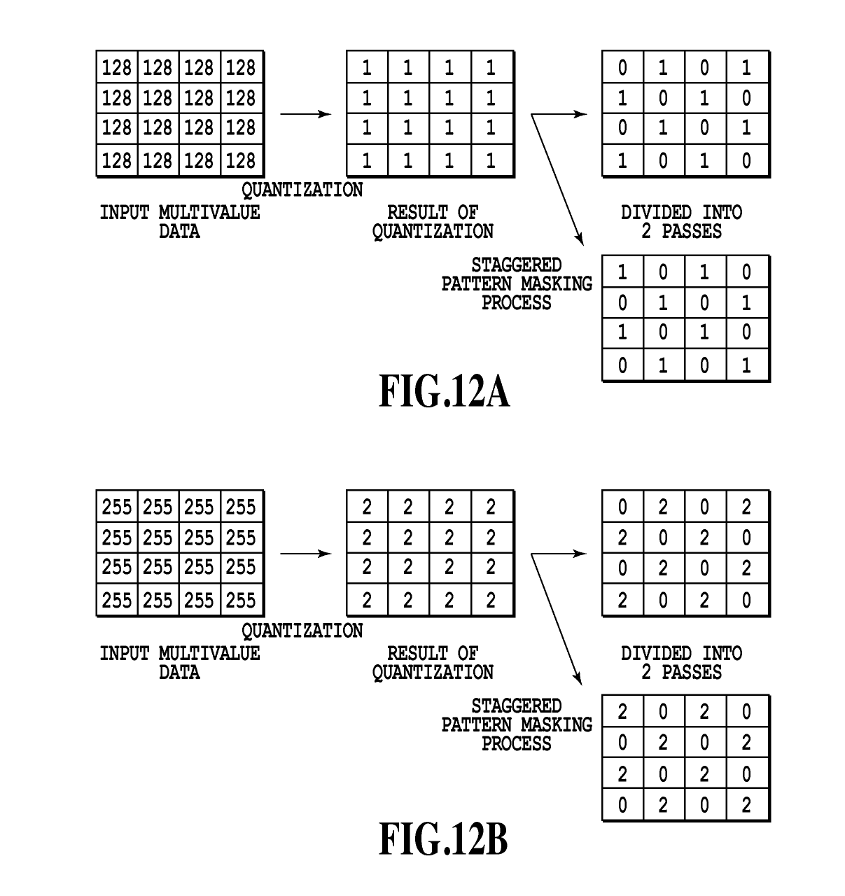

FIG. 13 is an explanatory diagram of a process for dividing image data, before being quantized, into two passes.

### DESCRIPTION OF THE EMBODIMENTS

Now, referring to the accompanying drawings, embodiments of this invention will be described.

### First Embodiment

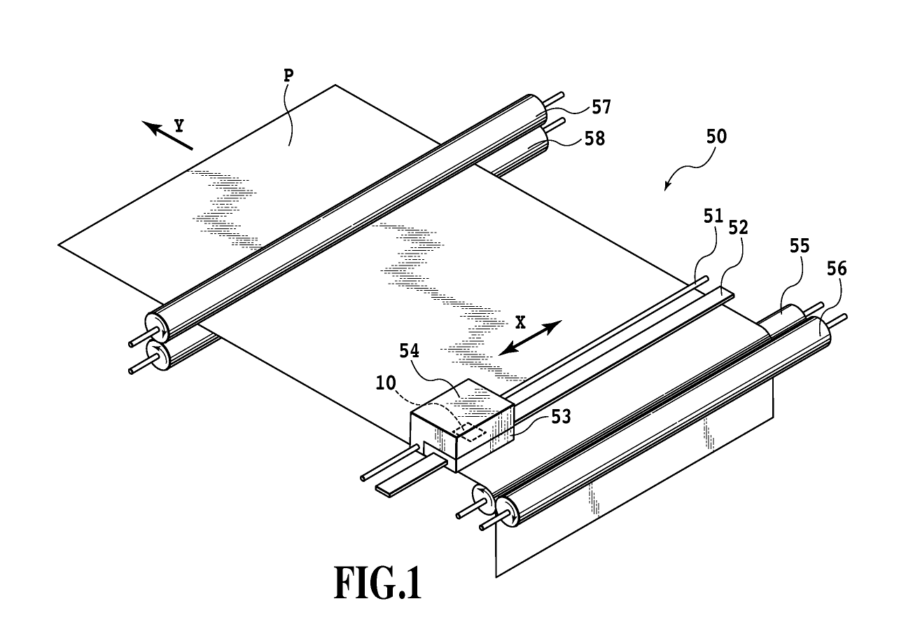

FIG. 1 is a perspective view showing an example construction of an inkjet printer (inkjet printing apparatus) of a serial scan type to which the present invention can be applied. This printer can be applied to a multipass printing technique that forms an image by scanning its print head two or more times over the same area of a print medium.

In the inkjet printer 50 of this example, a carriage 53 is guided by guide shafts 51, 52 so that it can move in a main scan direction of arrow X. The carriage 53 is reciprocated in the main scan direction by a carriage motor and a drive force transmission mechanism, such as belt, that transmits a drive force of the carriage motor. On the carriage 53 are mounted an inkjet print head 10 and an ink tank 54 for supplying ink to the print head 10. The print head 10 uses ejection energy generation elements, such as electrothermal conversion elements (heaters) or piezoelectric elements, to eject ink supplied from the ink tank 54 from its ejection openings. For example, in a print head using the electrothermal conversion elements, a bubble is formed in ink in each nozzle by heating of the associated electrothermal conversion element so that the expanding bubble expels an ink droplet from the ejection opening. The ink ejecting nozzles each comprise the ejection energy generation element and the ejection opening. A plurality of such nozzles are arrayed in a direction crossing the main scan direction (in this example, in a direction perpendicular to the main scan direction) to form a nozzle array. The print head 10 and the ink tank 54 may be integrally constructed to form an inkjet cartridge.

Paper P as a print medium is transported by feeding rollers 55, 56 and transport rollers 57, 58 in a sub-scan direction of arrow Y crossing the main scan direction (perpendicularly in this example). The printer progressively prints an image on the paper P by repetitively alternating a printing operation, which involves ejecting ink from the print head 10 onto the paper P as the print head 10 is moved in the main scan direction, and a transporting operation, which transports the paper P a predetermined distance in the sub-scan direction.

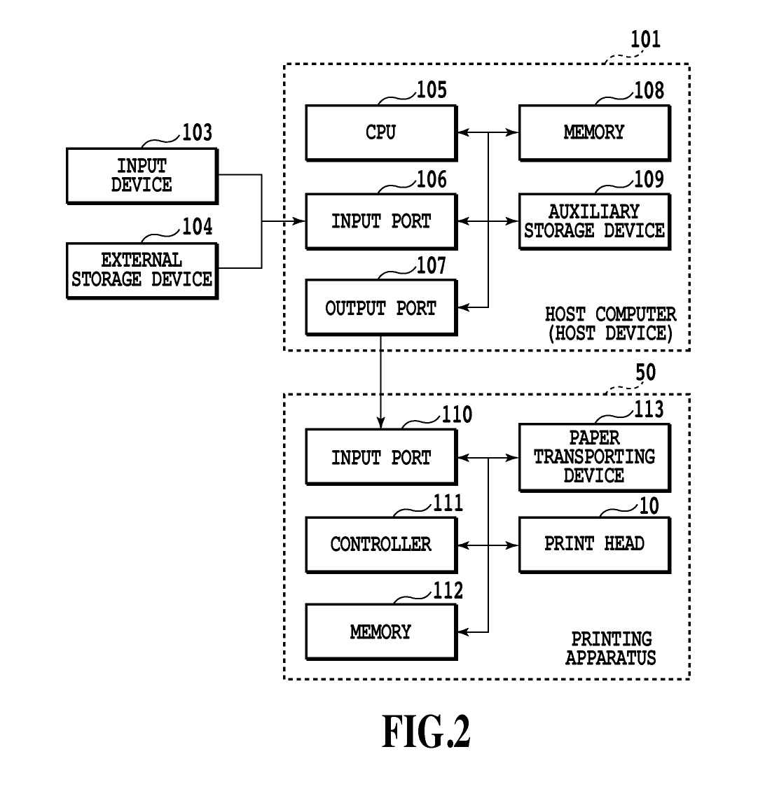

FIG. 2 shows an outline block configuration diagram of a control system of the printer 50.

A host computer (host device) 101 connectable to the printer 50 has a CPU 105, an input port 106 such as LAN and USB port, an output port 107, a memory 108, and an auxiliary storage device 109. To the input port 106 of the host computer 101, an input device 103 such as scanner and digital camera, and an external storage device 104 such as CD-ROM drive and memory card reader are connected. The output port 107 of the host computer 101 is connected to the printer 50.

The printer 50 has an input port 110, such as USB and LAN port to receive print data and control information, a control unit 111 to control the printer, and a memory 112 in which print data and inner setting information are held. A paper transporting device 113 is a device to transport the paper in the sub-scan direction and includes paper feeding rollers 55, 56 and paper transport rollers 57, 58.

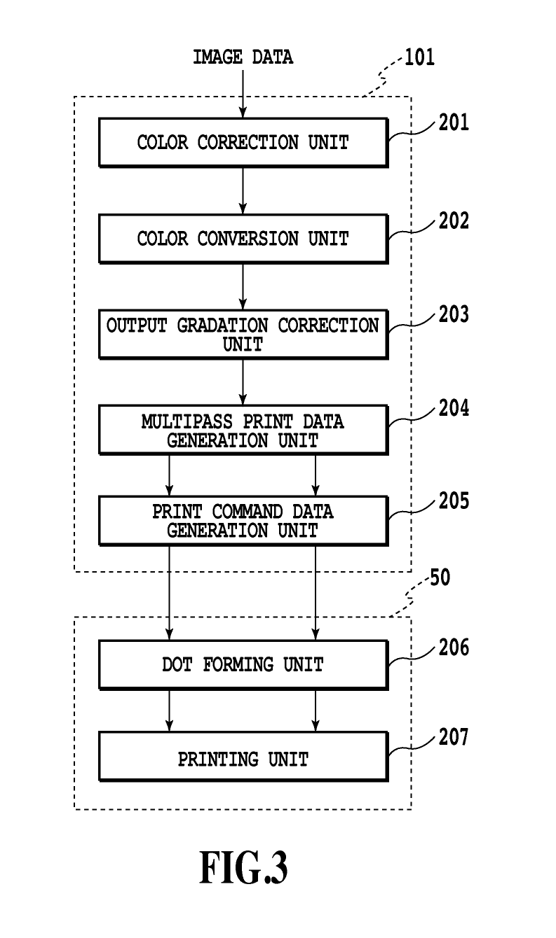

FIG. 3 shows an example configuration of a data processing system for generating data required by a multipass printing technique.

Image data to be printed by the printer 50 is supplied from the input device 103 or the like into the host computer 101. The entered color or grayscale image data undergoes a color correction in the color correction unit 201 according to the print setting made in the printer 50. The color-corrected image data is then converted in a color conversion unit 202 from RGB components, which are commonly used to represent image data, into CMYK components suited for printing by the printer 50.

The image data that has been converted into the CMYK components is subjected to the following output gradation correction by an output gradation correction unit 203. The relation between the number of ink dots formed in a unit print area and the output characteristic such as reflected density is normally not linear. This is due to a fact that the gradation characteristic of output data varies depending on which one of a variety of quantization methods, such as error diffusion method and dithering, is used in converting the data into pseudo-gradation levels and how a dot forming unit 206, described later, performs a dot arrangement. To assure a linear relationship between an input level of the image data that has been converted into CMYK components and an output characteristic of the printer 50, an output gradation correction is performed. In this embodiment, the output gradation correction suitably matches the quantization process executed by a multipass print data generation unit 204.

The multipass print data generation unit 204 converts data output from the output gradation correction unit 203 (input data) into multipass print data for each component of each color (multipass print data generation process). This multipass print data generation process will be described later. The multipass print data is converted by a print command data generation unit 205 into a print command for each component of each color that can be interpreted by the printer 50. The converted print data is sent to the printer 50 connected to the host computer 101. The host computer 101 may constitute an image processor to generate print data used by the printer 50. It is also possible to combine the host computer 101 with the printer 50 to form an image printing device to print an image.

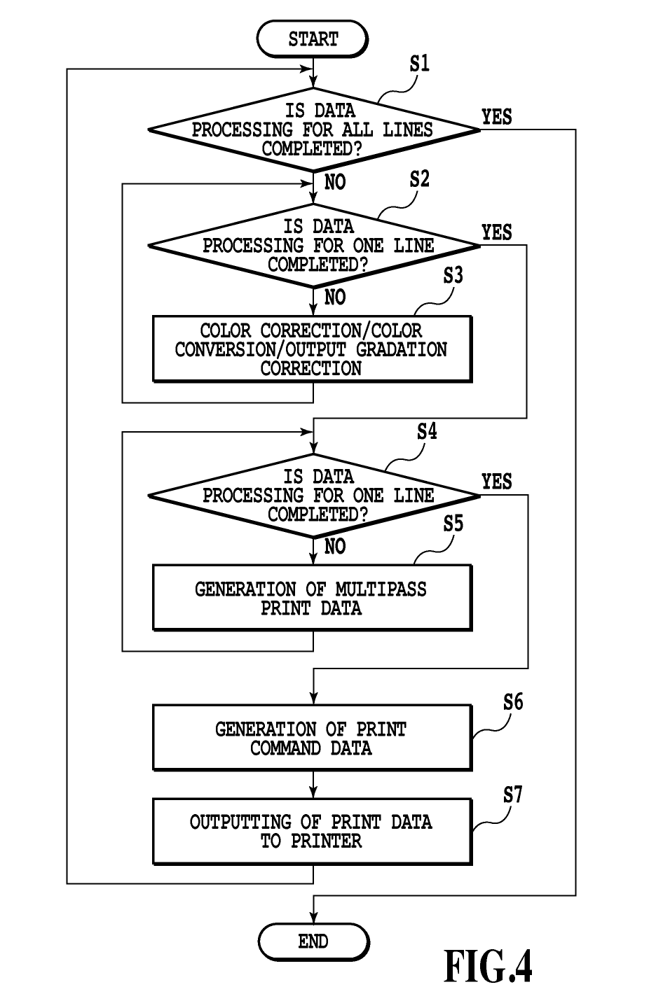

FIG. 4 is a flow chart explaining the image processing by the host computer 101 and the printer 50. While in this example the image data is processed one line at a time, the data processing may be done one pixel at a time or two or more lines at a time. Even an entire image may be taken as a unit.

First, at step S1 a check is made to see if image data for all lines has been processed. If so, the processing is ended. If the processing of image data for all lines has not yet finished, the process moves to step S2. Step S2 checks whether, for each pixel in the image data, the color correction by the color correction unit 201, the color conversion by the color conversion unit 202 and the output gradation correction by the output gradation correction unit 203 (step S3) have been completed.

When the color correction, color conversion and output gradation correction have been completed for one line in step S3, the processing moves to step S4. Step S4 checks whether the multipass print data generation process (step S5) by the multipass print data generation unit 204 is completed for individual pixels in one line of image data. When it is found that the multipass print data generation process for one line has finished, the processing moves to step S6. In step S6, the print command data generation unit 205 converts the multipass print data thus generated into print command data that can be interpreted by the printer 50 (print command data generation process). The converted print data is output to the printer 50 (step S7).

The printer 50 stores the received print data in a print buffer within the memory 112 (see FIG. 2). The dot forming unit 206 of the printer 50 determines, an arrangement of dots that are formed based on the print data, or formed by ink droplets ejected from the print head 10. The dot arrangement is determined depending on the type of gradation expression, such as the multidrop technique and droplet modulation technique described above.

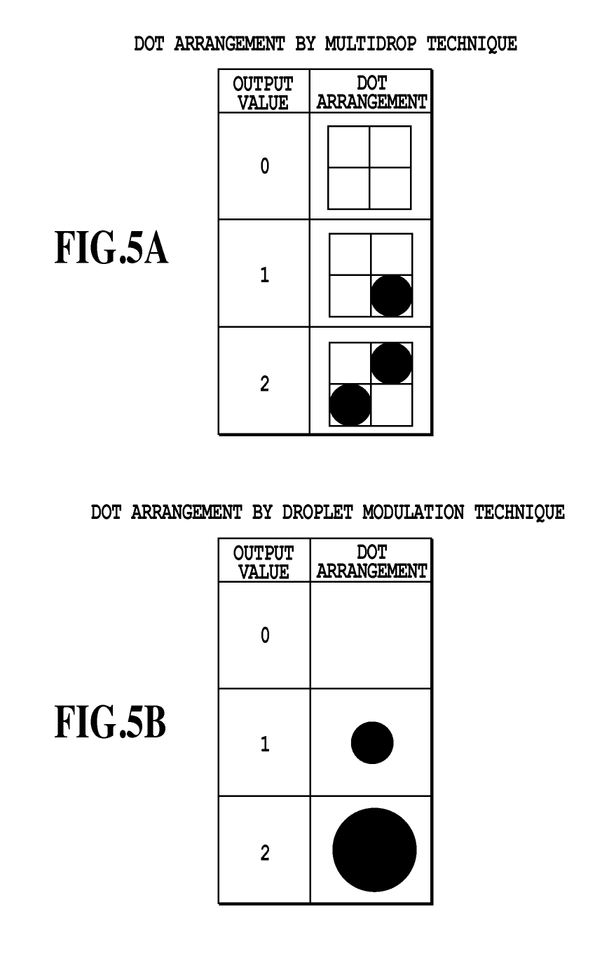

FIG. 5A and FIG. 5B are explanatory diagram showing examples of dot arrangement when the multidrop technique and the droplet modulation technique are used. In this example, the multipass print data generation unit 204 generates three-level print data by converting multivalue image data into print data that has one of three output values (0, 1, 2).

FIG. 5A shows an example arrangement of dots D formed by the multidrop technique when one pixel is allocated 2×2 areas. FIG. 5B shows an example arrangement of dots D1, D2 formed by the droplet modulation technique when one pixel is allocated 2×2 areas. The dots D1, D2 are formed by ink droplets of different volumes, with the small-diameter dot D1 formed by a small ink droplet and the large-diameter dot D2 by a large ink droplet.

As described above, the gradation level is expressed by arranging dots according to the output value 0, 1, 2. In the gradation level expression method, such as multidrop technique and droplet modulation technique, differences in the gradation characteristic resulting from the way the dots are arranged are absorbed, as described above, by the output gradation correction unit 203 executing the output gradation correction that suitably matches the way the dots are arranged. This guarantees the linear relationship between the input level of image data and the output characteristic of the printer. The droplet modulation technique used in this example to express the gradation level of one pixel is intended to prevent the generation of data involving small ink droplets that are easily influenced by air flows, by performing a process described later.

The dot forming unit 206 determines the dot arrangement as described above and the printing unit 207 including the print head 10 prints an image based on the dot arrangement. The printing unit 207 ejects ink from its print head 10 to print an image on the paper P fed by the paper transporting device 113. In a 2-pass printing method, the print head 10 scans twice over one line, as described above.

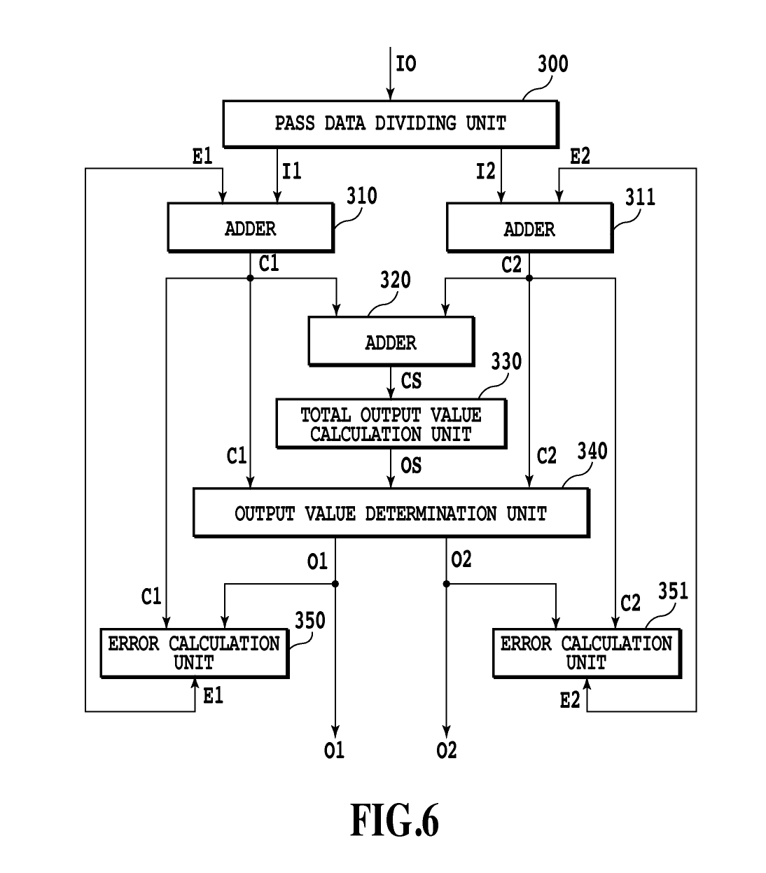

Next, the multipass print data generation process executed by the multipass print data generation unit 204 shown in FIG. 3 will be explained by referring to FIG. 6. FIG. 6 is a configuration block diagram of the multipass print data generation unit 204. Generally, image data is processed independently for each component of each color, so the explanation that follows concerns the data processing for one color. The multipass print data generation unit 204 of this example quantizes 8-bit (0-255) input data (image data) for each color inputted from the output gradation correction unit 203 and outputs three-value (0, 1, 2) print data for each pass. In this example therefore, the image data has 256 gradation levels while the print data has three gradation levels.

The multipass print data generation unit 204 has its pass data dividing unit (dividing means) 300 in which input data 10 from the color correction unit 201 is divided into input pass data I1, I2 for two passes. I1 and 12 have an allocation percentage of 50% each. Because the input data 10 is divided in a way that allocates 50% of the data to each of the two passes, the input pass data I1, I2 can take up data ranges of 0-127 and 0-128, respectively. Adders (correction means) 310, 311 add up the values of input pass data I1, I2 for each pixel and the values (correction values) of the error data E1, E2 for each pixel and output corrected input values C1, C2. The error data E1, E2 are calculated based on output values O1, O2 of pixels already quantized, as described later. An adder (addition means) 320 outputs a total corrected input value CS, an addition of the corrected input values C1, C2. A total output value calculation unit (quantization means) 330 outputs a total output value OS by quantizing the total corrected input value CS. The total corrected input value CS has 256 gradation levels and the total output value OS three levels.

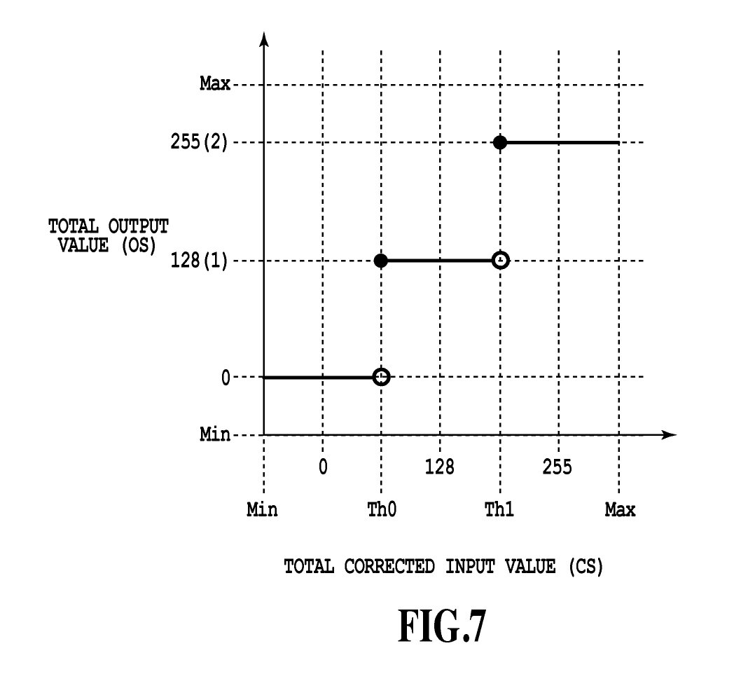

FIG. 7 shows processing executed by the total output value calculation unit 330. In this example a 3-value conversion is taken up as the quantization process. FIG. 7 shows an input/output characteristic of the total output value calculation unit 330, with an abscissa representing the total corrected input value CS and an ordinate the total output value OS.

Thresholds at which the total output value calculation unit 330 determines the output value (0, 1, 2) are Th0 and Th1 (Th0<Th1). The total corrected input value CS can be expressed by equation (1) below. A range of the total corrected input value CS is expressed as Min−Max (Min≦0, 255 Max).

$$\begin{matrix}CS = C 1 + C 2 \\ = I 1 + E 1 + I 2 + E 2 \\ = I 0 + EA + EB\end{matrix} \qquad ( 1 )$$

The total output value OS output from the total output value calculation unit 330 is 0 when the total corrected input value CS is less than Th0, 128 (3-value output is 1) when CS is equal to or greater than Th0 and less than Th1, and 255 (3-value output is 2) when CS is equal to or greater than Th1. These total output values OS are represented by solid lines in FIG. 7.

An output value determination unit (generation means) 340, based on the corrected input values C1, C2 for each pass, divides the total output value OS into an output O1 and an output O2 and allocates them to the first pass and the second pass respectively. At this time, the total output value OS is distributed unevenly to these passes. In this example, the total output value OS is allocated only to one of the output values O1, O2. That is, when C1>C2, the total output value OS is allocated only to the output value O1, i.e., O1=OS and O2=0. When C1≦C2, the total output value OS is allocated only to the output value O2, i.e., O1=0 and O2=OS. Therefore, the output value determination unit 340 allocates all of the total output value OS to one of the plurality of passes with the largest corrected input value and 0 to the remaining passes. The output data of the output value determination unit 340, i.e., output data of the multipass print data generation unit 204 (output values O1, O2) takes one of the converted three values of 0, 1, 2.

Error calculation units (error calculation means) 350, 351 take in the output values O1, O2 from the output value determination unit 340 and corrected input values C1, C2 from the adders 310, 311, calculates differences between them and outputs error data E1, E2. The values of the error data E1, E2 can be determined by the following equations (2-1) and (2-2). O1 and O2 are 0, 128 or 255.

E1=C1−O1 (2-1)

E2=C2−O2 (2-2)

These error data E1, E2 are input to the adders 310, 311 respectively and added to the input pass data I1, I2 to be taken in the next time.

As described above, one of input data I0 is processed. By repetitively shifting the process one pixel at a time in the direction of processing, multipass print data corresponding to each pass for printing the entire image is generated.

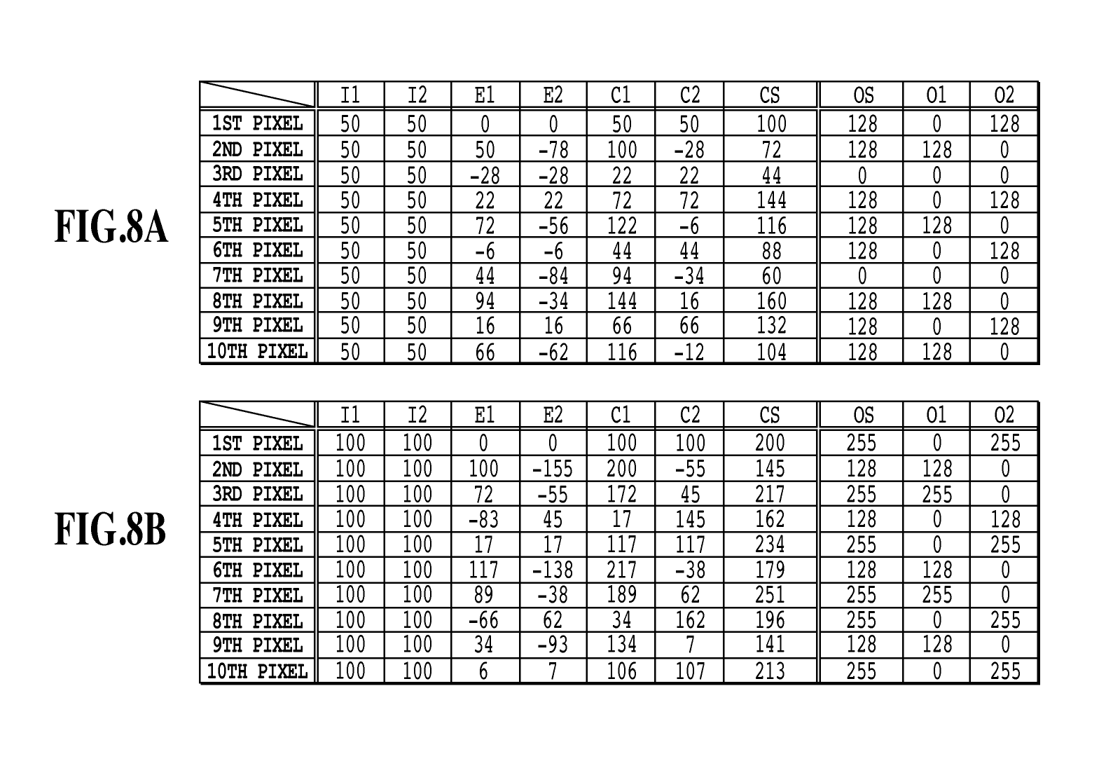

Next, an example result of calculating the multipass print data in this embodiment will be explained by referring to FIG. 8A and FIG. 8B.

In FIG. 8A and FIG. 8B, the thresholds in the total output value calculation unit 330 are set at Th0=64 and Th1=192. FIG. 8A represents a case where a solid image with a value of input data 10 (input value) of 100 is printed; and FIG. 8B represents a case where a solid image with a value of input data 10 (input value) of 200 is printed. The pass data dividing unit 300 divides the input data 10 into the input pass data I1, I2 at an allocation percentage of 50%. So, in the case of FIG. 8A, the input pass data I1, 12 always have a value of 50 each (I1=50, I2=50); and in the case of FIG. 8B, the values of input pass data I1, I2 are always 100 (I1=100, I2=100).

First, the process in the case of FIG. 8A will be explained, beginning with the first pixel.

At the first pixel, since there is no error data E1, E2 from the preceding pixel, E1=0 and E2=0. Adding the error data E1, E2 and the input pass data I1, I2 results in the corrected input values C1, C2 of C1=50 and C2=50. Adding up these corrected input values C1, C2 gives a total corrected input value CS of 100 (=50+50), which falls between Th0 (=64) and Th1 (192). So the total output value OS is 128. Since C1≧C2, the total output value OS of 128 is divided into O1=0 and O2=OS (=128). Further, from equations (2-1) and (2-2), the error data E1, E2 to be allocated to the next pixel are E1=50 (=50−0) and E2=−78 (=50−128). These error data E1, E2 are used as E1, E2 for the second pixel in FIG. 8A.

The similar process is also performed on the second and subsequent pixels and the processing results are shown in FIG. 8A for up to 10th pixels. The same also holds for FIG. 8B.

As can be seen from FIG. 8A and FIG. 8B, since the total corrected input value CS of corrected input values C1, C2 for two passes is supplied to the quantization process, the Min-Max value range that the total corrected input value CS can take is Min≦0 and Max≧255. Then the total corrected input value CS is quantized and the output values O1, O2 to be allocated to two passes can be chosen from one of the converted three values 0, 1, 2.

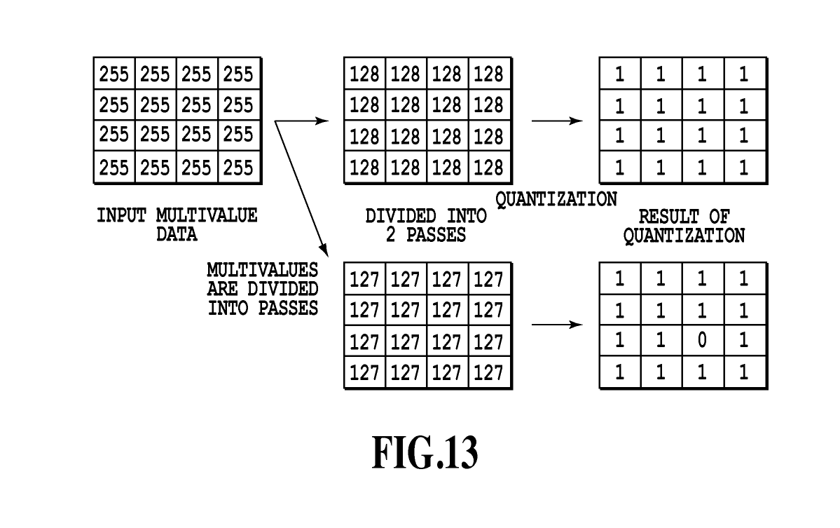

As a result of the above processing, if the maximum print density for each pass is lowered by dividing unquantized multivalue image data, the output value for each pass will not become 100% or nearly 100% “1” as they do in the case of Japanese Patent Laid-Open No. 2000-103088 of FIG. 13. That is, in dividing unquantized multivalue image data into portions for individual passes and quantizing the divided multivalue image data, the range of value of the image data to be quantized (total corrected input value CS) can be widened. This can prevent ink droplets corresponding to the output value 1, i.e., small ink droplets easily influenced by air flows, from being ejected successively as they are in FIG. 13.

Further, in this example, the pass data dividing unit 300 allocates the input data I0 into the input pass data I1, I2 at an allocation percentage of 50%. Hence, if the total output value OS is 1 or 2, the allocation percentages at which the total output value OS is allocated to the first pass output value O1 and the second pass output value O2 are almost 50%. This is because, by the output value determination unit 340, all of the total output value OS is allocated to only one of the first and second pass which has a larger corrected input value C1 or C2, with the other pass allocated with 0. In other words, since the total output value OS is allocated partially only to whichever of the two passes has a greater corrected input value C1 or C2, the allocation percentage at which to allocate the OS to each of the two passes can be controlled according to the allocation percentage at which the pass data dividing unit 300 divides and allocates the input data I0 to each of the two passes. That is, the frequency at which the quantized value of 1 or 2 is output as the print data for each pass can be controlled according to the allocation percentage at which the pass data dividing unit 300 allocates the input data I0 to each of the two passes.

Where the unquantized multivalue image data is divided into portions for two passes which are then quantized, it is possible to control the frequency at which a predetermined quantized value is output while widening the range of value that the image data to be quantized can take. This means that the air flow-induced density variations that becomes discernible in the case of FIG. 13 can be reduced. That is, by reducing the number of passes to increase the printing speed while reducing the air flow-induced density variations, it is possible to realize a high-speed printing and an improved quality of the printed image at the same time.

### Second Embodiment

In the aforementioned first embodiment, in order to partially allocate the total output value to a predetermined pass, the output value determination unit 340 allocates the total output value only to whichever of a plurality of passes has the largest corrected input value. However, in a high density print area—an area where the total output value has become large because of the partial allocation of the total output value to a predetermined pass—the number of pixels to which an output 0 is assigned increases. If this happens, variations in ink droplet landing position (variations in ink droplet ejection direction and ink droplet size) and printed area deviations among passes may become conspicuous. To deal with this problem, the allocation technique may be switched to a different one depending on the total output value when the output value determination unit 340 allocates the total output value partially to the predetermined pass.

As one method of switching between different allocation techniques depending on the total output value, a method of creating print data with four output levels, or 4-value print data, will be explained. The 4-value print data has one of output values 0, 1, 2, 3.

When the total output value is 1 or 2, which is likely to occur in low density print areas, the total output value OS is allocated only to the pass with the maximum corrected input value, as in the preceding embodiment. That is, If C1>C2, the total output value OS is allocated to the output value O1, i.e., O1=OS and O2=0. If C1≦C2, the total output value OS is allocated to the output value O2, i.e., O1=0 and O2=OS.

When, on the other hand, the total output value is 3, which is likely to occur in high density print areas, the total output value OS is allocated to two passes according to which of the corrected input values C1, C2 is greater. For example, if C1>C2, the total output value OS is divided into the output values O1, O2 at a ratio of 2:1, i.e., O1=2 and O2=1. If C1≦C2, the total output value OS is divided into the output values O1, O2 at a ratio of 1:2, i.e., O1=1 and O2=2.

As described above, when the output value determination unit 340 partially allocates the total output value to a predetermined pass, a switch is made between the two allocation procedures according to the total output value. One of the two procedures is to allocate all of the total output value only to one pass having the maximum corrected input value and the other is to divide and allocate the total output value to two or more passes at different allocation percentages such that the sum of the allocated output values equals the total output value. By switching between the different allocation procedures, those of the high density print areas which are allocated with the output value of 0 can be reduced as much as possible to render ink droplet ejection direction and ink droplet size variations and printed area deviations among different passes unnoticeable. If the linear relationship between the input level of image data and the output characteristic of the printer when the output value of 3 is distributed among two or more passes differs from that when the output value of 1 or 2 is allocated to only one pass, the difference need only be absorbed by the output gradation correction process.

### Third Embodiment

In addition to the method of the second embodiment described above, when the output value determination unit 340 partially allocates the total output value to a predetermined pass, the allocation procedure can be changed at a predetermined ratio according to the total output value, thereby more finely controlling the frequency at which a particular output value occurs.

As an example method of switching between different allocation procedures at a predetermined ratio according to the total output value, an explanation is given to a case in which 3-value print data is created. The 3-value print data can take one of output values 0, 1, 2.

When the total output value is 1, which is likely to occur in low density print areas, the total output value OS is allocated only to the pass with the greatest corrected input value, as in the preceding embodiment. That is, if C1>C2, the total output value OS is allocated only to the output value O1, i.e., O1=OS and O2=0; and if C1≦C2, the total output value OS is allocated only to the output value O2, i.e., O1=0 and O2=OS. A procedure of allocating all of the total output value only to a scan with the largest corrected input value is referred to as a first allocation mode.

When, on the other hand, the total output value is 2, which is likely to occur in high density print areas, the total output value OS is divided and distributed to passes according to the magnitudes of corrected input values C1, C2. That is, for a predetermined percentage of the total output values 2 that occur two or more times, each of them is equally divided and allocated to the passes. For the remaining percentage, the total output value 2 is wholly allocated to a pass having the largest corrected input value. In this manner the process of allocating the total output value OS is changed. For example, for 20% of the total output values 2 that occur two or more times, each of them is equally divided and allocated to the passes, i.e., O1=1 and O2=1. For the remaining 80%, when C1>C2, each of the total output values OS is wholly allocated only to the output value O1, i.e., O1=2 and O2=0; and when C1≦C2, each of the total output values OS is wholly given only to the output value O2, i.e., O1=0 and O2=2. This allocation procedure that distributes each of a predetermined percentage of the total output values to two or more passes such that the sum of the allocated values equals the total output value is referred to as a second allocation mode.

By switching at a predetermined ratio between the first allocation mode, that allocates the output level only to one pass, and the second allocation mode, that distributes the output level to two passes, the frequency at which a specific quantized value is created can be finely controlled. This enables ink dots to be arranged more appropriately according to the output characteristic of the printer in an allowable range of density variations caused by air flows and in an allowable range of variations in ink droplet ejection direction and ink droplet size and of printed area deviations among different passes.

In this example, when the output value is 2, the two allocation modes—one that divides and distributes the output level to two passes and one that allocates the output level only to one pass—are switched at a predetermined ratio. The switching method may involve counting the number of pixels having the output value of 2 and, based on the count value, switching between the two allocation modes. Another switching method may also be used which refers to random numbers and tables in switching between the two allocation modes. The switching method is not limited to those described above.

As described above, by switching between the two allocation modes at a predetermined ratio when the output value determination unit 340 allocates the total output value to the two passes, the frequency at which to output a specific quantized value can be more finely controlled. This enables dots to be arranged in a way that better matches the output characteristic of the printer, reducing density variations caused by air flows while executing a high-speed printing with a reduced number of passes, offering a unique combination of the high-speed printing and the improved quality of printed images.

### Fourth Embodiment

In the above first to third embodiment, the output from the output value determination unit 340 is used, as is, as an output value for each pass, i.e., an output value of the multipass print data generation unit 204. It is also possible to switch between a mode in which the output from the output value determination unit 340 is used as an output value for each path and a mode in which a value, independently quantized for each pass from the corrected input value, is used as an output value for each pass.

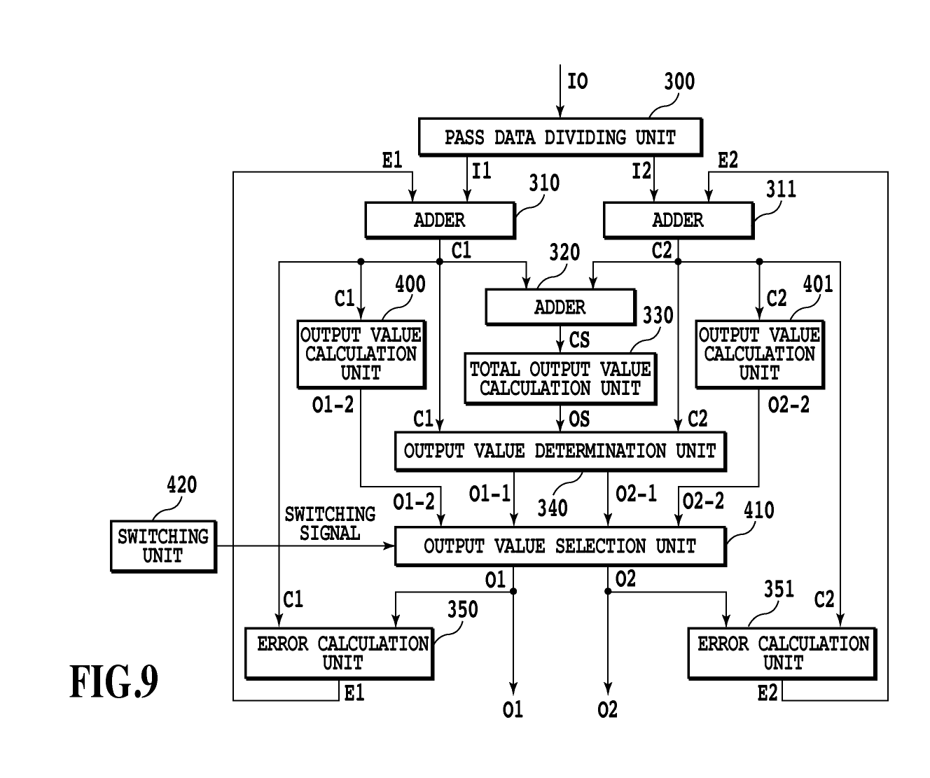

FIG. 9 shows an example configuration of the multipass print data generation unit 204 that allows for such a mode switching.

The configuration shown in FIG. 9 has, in addition to the configuration of FIG. 6, output value calculation units 400, 401, an output value selection unit 410 and a switching unit 420. The output value calculation units 400, 401, equivalent to the second generation means, quantize the corrected input values C1, C2 for individual passes independently of each other. The output value selection unit 410, based on a switching signal from the switching unit 420, switches between a first mode, that uses the output values from the output value determination unit 340 as output values O1, O2 for two passes, and a second mode, that uses the output values from the output value calculation units 400, 401 as output values O1, O2 for two passes. The output value selection unit 410 corresponds to the selection means. In FIG. 9, the output values O1, O2 from the output value determination unit 340 in FIG. 6 are used as output values O1-1, O2-1 and the output values from the output value calculation units 400, 401 as output values O1-2, O2-2.

In this example, a process of generating 3-value print data will be explained. The 3-value print data takes one of output values 0, 1, 2. In high density print areas, when the total output value OS from the total output value calculation unit 330 is 2, the switching unit 420 issues a switching signal for the output value selection unit 410 to select the second mode. When the total output value OS is other than 2 (i.e., 0, 1), the switching unit 420 gives a switching signal for the output value selection unit 410 to select the first mode. In the following, explanations about the processing by those components that are identical with those of FIG. 6—pass data dividing unit 300, adders 310, 311, 320, total output value calculation unit 330 and output value determination unit 340—will be omitted.

The corrected input values C1, C2 for two passes output from the adders 310, 311 are independently quantized by the output value calculation units 400, 401. The quantized output values O1-2, O2-2 are output to the output value selection unit 410. Explanations about the output value calculation units 400, 401 will be omitted as they perform the same processing as that of the total output value calculation unit 330 already described. The output values O1-1, O2-1 from the output value determination unit 340 are also given to the output value selection unit 410.

The output value selection unit 410, based on the switching signal from the switching unit 420, selects either the output values O1-1, O2-1 or the outputs O1-2, O2-2 as final output values O1, O2 for two passes. In this example, when the total output value OS is 2, the output values O1-2, O2-2 are chosen as the final output values O1, O2. When the total output value OS is 0 or 1, the output values O1-1, O2-1 are selected as the final output values O1, O2. The output values O1, O2 from the output value selection unit 410 will become an output from the multipass print data generation unit 204 and at the same time input to the error calculation units 350, 351. Other processing does not need explanation as they are similar to those of FIG. 6.

As described above, when the total output value OS is 2, which is likely to occur in high density print areas, the output values O1-2, O2-2, that are independently quantized from the corrected input values C1, C2 for two passes, are selected as the final output values O1, O2 for two passes. This can minimize the effects that variations in ink droplet ejection direction and ink droplet size and print area deviations between two passes have on the density of printed image, as in the case of Japanese Patent Laid-Open No. 2000-103088. As in the preceding embodiments 1 to 3, the fourth embodiment can arrange dots in ways that are more suited to the output characteristics of the printer, which in turn allows for realizing high-speed printing with reduced number of passes.

In this embodiment, either the first or second mode of output allocation is selected according to the total output value OS. The method of selecting the allocation mode, however, may also be based on the corrected input values C1, C2 for two passes. There are other methods that may be used for switching between the first and second allocation mode, such as one that involves counting the number of pixels having a predetermined output value and switching between the first and second allocation mode at a ratio determined by that count and one that switches between the first and second mode at a ratio determined by referencing random numbers and tables. It is also noted that the allocation mode switching is not limited to these methods.

### Fifth Embodiment

In the first embodiment, the total output value calculation unit 330 performs the quantization process by comparing a total corrected input value CS with a threshold. The total output value calculation unit 330, however, may also determine the total output value OS by referring to a lookup table that provides associations between the total corrected input value CS and the total output value OS.

In the preceding embodiments, the error data E1, E2 calculated by the error calculation units 350, 351 have been shown to be allocated and added only to the next pixel to be processed. These error data E1, E2, however, may be distributed to a plurality of neighboring pixels according to weighted coefficients that are empirically determined, as is done in the generally known error diffusion method. Furthermore, it is possible to change the weighted coefficients and thresholds used to distribute the error data E1, E2 according to the pixel positions and input data so as to produce slightly different quantization results among print areas of different passes.

As described above, by constructing the total output value calculation unit 330 and the error calculation units 350, 351 to slightly differentiate the quantization results among print areas of different passes, dot arrangement patterns in print areas of different passes can be made to hardly interfere with one another. This improves the quality of printed images.

### Sixth Embodiment

The objective of this invention can be achieved by storing in a storage medium the program codes that realize the functions of the aforementioned embodiments and providing the storage medium to a system or apparatus. That is, the objective of this invention can be accomplished by a computer (or CPU or MPU) of the system or apparatus reading the program codes stored in the medium and executing them. In that case, the program codes read out from the storage medium realize the functions of the aforementioned embodiments, so the medium storing the program codes constitutes this invention.

The storage media in which to store program codes include, for example, flexible disks, hard disks, optical discs, magnetooptical discs, CD-ROMs, CD-Rs, magnetic tapes, nonvolatile memory cards, ROMs and DVDs.

The functions of the aforementioned embodiments can be achieved not just by the computer reading program codes and executing them. They can also be realized, for example, by causing an operating system (OS) running on the computer to execute a part or all of the actual processing. Further, the program codes that are read from the storage medium in the above example may be written into a function expansion board inserted in the computer or into a memory installed in a function expansion unit connected to the computer. In that case, the CPU on the function expansion board or function expansion unit executes a part or all of the actual processing according to instructions dictated by the written program codes to realize the functions of the aforementioned embodiments.

The processing done by the aforementioned embodiments may be shared by a plurality of devices (e.g., host computer and printing apparatus) or performed entirely by a single device. Furthermore, while in the aforementioned embodiments, the host device as an image processor has been shown to be separate from the printing apparatus, the image processor may be configured to be a printing apparatus with a printing unit.

While in the aforementioned embodiments the 2-pass printing has been taken up as an example, it is needless to say that this invention can also be applied to printing operations with three or more passes. Although the print data has been described to be 3-value data, it may have three or more values. When, for example, the print data has five values, the method of the first embodiment allocates all of the value “5” to one of the scans and the method of the second embodiment allocates the value “5” to two scans at a ratio of 2:3 or 3:2.

Ink droplets ejected from the print head are not limited to two kinds—large ink droplets and small ink droplets—but may have three different sizes of ink droplets. As long as the print head is configured to eject at least two different volumes of ink droplets (large and small ink droplets), the present invention can minimize the use of small ink droplets that are easily influenced by air flows, by executing the processing in the aforementioned embodiments.

### Other Embodiments

The print head applicable to this invention may also include, in addition to an inkjet print head, a thermal head or other types of print head. The only requirement is that the print head be able to print images by forming a plurality of pixels on a print medium using a plurality of printing elements. Further, this invention can be applied widely to multipass printing with two or more passes.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-057495, filed Mar. 15, 2010, which is hereby incorporated by reference herein in its entirety.

What is claimed is:

1. An image processor for generating print data used to print an image on a print medium, wherein the image is printed on the print medium by scanning a print head over the same print area of the print medium a plurality of times, the print head being adapted to eject at least two kinds of ink droplets of different volumes onto each pixel according to a value of the print data for the pixel, the image processor comprising:
a dividing unit configured to divide a value of image data, whose range is wider than that of the print data, into portions, one for each scan;
a correction unit configured to correct each of the divided portions of the image data with a correction value of each scan to determine a corrected input value for each scan;
an addition unit configured to add up the corrected input values for the individual scans to calculate a total corrected input value;
a quantization unit configured to quantize the total corrected input value into a value corresponding to the print data to create a total output value; and
a generation unit configured to allocate the total output value unevenly to the plurality of scans to create the print data for each scan.

2. The image processor according to claim 1, further comprising an error calculation unit configured to calculate as the correction value for each scan an error between the value of the print data for each scan and the total corrected input value for each scan.

3. The image processor according to claim 1, wherein the generation unit allocates all of the total output value to a scan having the largest of the correction values among the plurality of scans.

4. The image processor according to claim 1, wherein the generation unit switches between a first allocation mode and a second allocation mode according to the total output value, the first allocation mode being adapted to allocate all of the total output value to whichever of the plurality of the scans has the largest correction value, the second allocation mode being adapted to allocate the total output value to two or more scans so that a sum of the values allocated to the two or more scans is equal to the total output value.

5. The image processor according to claim 4, wherein the generation unit switches between the first allocation mode and the second allocation mode at a predetermined ratio according to the total output value.

6. The image processor according to claim 1, wherein the quantization unit creates the total output value by comparing the total corrected input value and a predetermined threshold.

7. The image processor according to claim 1, wherein the quantization unit creates the total output value by referring to a table matching the total corrected input value to the total output value.

8. The image processor according to claim 1, further comprising:
a second generation unit configured to quantize the corrected input value for each scan into a value corresponding to the print data and generate the print data for each scan according to the quantized value; and
a selection unit configured to select between the print data generated by the generation unit and the print data generated by the second generation unit.

9. An image processing method for generating print data used to print an image on a print medium, wherein the image is printed on the print medium by scanning a print head over the same print area of the print medium a plurality of times, the print head being adapted to eject at least two kinds of ink droplets of different volumes onto each pixel according to a value of the print data for each pixel, the image processing method comprising the steps of:
dividing a value of image data, whose range is wider than that of the print data, into portions, one for each scan;
correcting a value of each of the divided portions of the image data with a correction value of each scan to determine a corrected input value for each scan;
adding up the corrected input values for the individual scans to calculate a total corrected input value;
quantizing the total corrected input value into a value corresponding to the print data to create a total output value; and
allocating the total output value unevenly to the plurality of scans to create the print data for each scan.

10. An image printing method for printing an image on a print medium by scanning a print head over the same print area of the print medium a plurality of times, wherein the print head ejects at least two kinds of ink droplets of different volumes onto each pixel according to a value of print data for each pixel which is obtained by quantizing a value of image data for each pixel, the image printing method comprising the steps of:
dividing the value of the image data, whose range is wider than that of the print data, into portions, one for each scan;
correcting a value of each of the divided portions of the image data with a correction value of each scan to determine a corrected input value for each scan;
adding up the corrected input values for the individual scans to calculate a total corrected input value;
quantizing the total corrected input value into a value corresponding to the print data to create a total output value; and
allocating the total output value unevenly to the plurality of scans to create the print data for each scan.

11. A storage medium storing a computer-readable program, wherein the program causes a computer to execute the following steps to generate print data used to print an image on a print medium, wherein the image is printed on the print medium by scanning a print head over the same print area of the print medium a plurality of times, the print head being adapted to eject at least two kinds of ink droplets of different volumes onto each pixel according to a value of the print data for each pixel, the steps including:
a dividing step to divide a value of image data, whose range is wider than that of the print data, into portions, one for each scan;
a correction step to correct each of the divided portions of the image data with a correction value of each scan to determine a corrected input value for each scan;
an addition step to add up the corrected input value for the individual scans to calculate a total corrected input value;
a quantization step to quantize the total corrected input value into a value corresponding to the print data to create a total output value; and
a generation step to allocate the total output value unevenly to the plurality of scans to create the print data for each scan.
